(19) United States
(12) Patent Application Publication
(10) Pub. No.: US 2018/0175385 A1
(43) Pub. Date: Jun. 21, 2018

(54) Graphene-Vanadium Oxide Nanowire, Method for Preparation Thereof, Positive Active Material Comprising the Same and Lithium Battery Comprising the Positive Active Material

(71) Applicant: Korea Basic Science Institute, Daejeon (KR)

(72) Inventors: Won Gi HONG, Daejeon (KR); Hae Jin KIM, Daejeon (KR); Jin Bae LEE, Daejeon (KR); Sang Moon LEE, Daejeon (KR); Yeon Ho KIM, Daejeon (KR)

(21) Appl. No.: 15/818,639

(22) Filed: Nov. 20, 2017

(30) Foreign Application Priority Data
Dec. 16, 2016 (KR) 10-2016-0172948

(51) Int. Cl. H01M 4/48; H01M 4/36; H01M 10/0525; H01M 4/38; H01M 4/133; H01M 4/587; C01G 31/02; C01B 32/198

(52) U.S. Cl. CPC H01M 4/483; H01M 4/366; H01M 10/0525; H01M 4/382; H01M 4/133; C01P 2006/40; C01G 31/02; C01B 32/198; H01M 2220/20; C01P 2004/16; H01M 4/587

(57) ABSTRACT

The present disclosure is directed to a graphene-vanadium oxide nanowire including a nanowire core including vanadium oxide and a shell formed on the surface of the nanowire core and including graphene oxide. The graphene-vanadium oxide nanowire having improved capacity stability can be provided by using the graphene-vanadium oxide nanowire according to the present disclosure, the method for preparing the same, and a positive active material and a secondary battery including the same. In addition, by using the graphene-vanadium oxide nanowire according to the present disclosure as a positive active material, it is possible to provide a secondary battery having improved cycle characteristics and capacity retention rates.

### CROSS-REFERENCE TO RELATED APPLICATIONS

This application claims the benefit under 35 U.S.C. 119(a) of Korean Patent Application No. 10-2016-0172948 filed on Dec. 16, 2016 in the Korean Intellectual Property Office, the entire disclosure of which is incorporated herein by reference for all purposes.

### BACKGROUND

### Field

The present disclosure relates to a graphene-vanadium oxide nanowire, a method for preparing the same, and a positive active material and a secondary battery including the same. More particularly, the present disclosure relates to a graphene-vanadium oxide nanowire having high ion conductance and improved capacity stability, in which a vanadium oxide nanowire and graphene oxide are composed in the form of a core-shell, a method for preparation thereof, and a positive active material and a secondary battery including the same.

### Description of the Related Art

As technology development and demand for mobile devices have increased, demand for secondary batteries as an energy source has been rapidly increasing. Recently, the use of secondary batteries as power sources for electric vehicles and hybrid electric vehicles has been realized. Accordingly, a lot of studies have been made on a secondary battery capable of meeting various demands, and in particular, there is a high demand for a lithium secondary battery having a high energy density, a high discharge voltage, and an output stability.

Generally, a lithium secondary battery uses a metal oxide such as LiCoO₂ as a positive active material and a carbon material as a negative active material, and a polyolefin-based porous separation membrane is sandwiched between a cathode and an anode, and impregnated with a non-aqueous electrolytic solution having a lithium salt such as LiPF₆.

LiCoO₂ is widely used as a positive active material of a lithium secondary battery, but has many problems such that it is relatively expensive due to the limit of the amount of resources, the charge and discharge current amount is as low as about 150 mAh/g, the crystal structure is unstable at a voltage of 4.3 V or greater, and there is a risk of ignition caused by the reaction with the electrolyte. Moreover, LiCoO₂ has a disadvantage in that it exhibits a very large property change even when some parameters are changed on the preparation process.

As one of the options to solve such a problem of LiCoO₂, the technology of using various lithium transition metal oxides such as a lithium manganese composite oxide (Li_{z}MO₂), a mixed solution of two or more different lithium transition metal oxides, a vanadium oxide (V₂O₅) as positive active materials have been proposed.

Particularly, since vanadium oxide does not contain lithium, it can be used in a system using lithium metal, and therefore, for example, researches as a positive active material of a lithium secondary battery for an electric vehicle are actively under way.

As a method for synthesizing vanadium oxide, there has been a conventional synthesis method using an amorphous inducer (glass former). Particularly, when P₂O₅ is used as an amorphous inducer, it exhibits high capacity and excellent cycle characteristics. However, since it absorbs moisture easily in the atmosphere and requires rapid quenching in the synthesis process, there is a problem in the process.

In order to solve this problem, a synthesis method by a sol-gel method has been proposed. For example, a synthesis method by adding the water to V₂O₅ solution, a method of reacting vanadium alkoxide with the water, and a method of passing a cation exchange resin through a metavanadate solution have been proposed. In particular, a method using a metavanadate solution is gaining attention. However, since NaVO₃ is used as a precursor in the method, sodium may remain as an impurity, which may hinder the characteristics of the battery.

When vanadium oxide nanowires (or nanotubes) are prepared by such a sol-gel method, mass production is not easy, and it is difficult to control the length and specific surface area. Therefore, it is difficult to control the desired physical properties such as the output characteristics and the like, so that there is a limit to practical use as a positive active material.

In addition, as a method for preparing a vanadium oxide nanowire, U.S. Pat. No. 6,720,240 discloses a method for preparing a nanowire or a nanosphere under a condition of a temperature of 800 to 1,500° C. and a pressure of 200 to 650 Torr, using vanadium oxide (VO₂). U.S. Pat. No. 6,605,266 discloses a preparation method including mixing a transition metal oxide such as vanadium alkoxide with a hexadecylamine solution and hydrolyzing, aging and heating.

However, the above-mentioned preparation methods have to satisfy the conditions of high temperature and high pressure, or the preparation process is very complicated and cumbersome, and furthermore, the property control of the positive active material containing vanadium oxide is almost impossible.

Meanwhile, as a technique for crystallizing vanadium oxide, Korean Patent Application Laid-Open Publication No. 2005-001542 discloses the technique of depositing a positive active material such as vanadium oxide (V₂O₅) on a substrate in the form of a thin film, and then applying a negative bias voltage, in which the electrochemical characteristics of the positive active material are improved by crystallizing the same without a heat treatment process at a room temperature.

However, the positive active material including such a crystalline vanadium oxide has a reversible capacity range of only 1 mole per mole, and there is a problem in that the capacity is reduced through the irreversible phase change.

### SUMMARY

The present disclosure has been introduced to provide a graphene-vanadium oxide nanowire having improved capacity stability.

In addition, the present disclosure is introduced to provide a method for preparing graphene-vanadium oxide nanowires which is simple in preparation process and has improved capacity stability.

In addition, the present disclosure is introduced to provide a positive active material including graphene-vanadium oxide nanowires having improved capacity stability and a secondary battery including the same.

The present disclosure includes a nanowire core including vanadium oxide and a shell formed on the surface of the nanowire core and including graphene oxide.

Here, the shell may include graphene and graphene oxide.

Here, the vanadium oxide may include at least one selected from the group consisting of VO₂, V₂O₅, and V₃O₈.

Here, the nanowire core and the shell may have a mass ratio of 1:1 to 10:1.

A positive active material including graphene-vanadium oxide nanowires according to the present disclosure may include a nanowire core including vanadium oxide, and a shell formed on the surface of the nanowire core and including graphene oxide.

Here, the shell may include graphene and graphene oxide.

Here, the vanadium oxide may include at least one selected from the group consisting of VO₂, V₂O₅, and V₃O₈.

Here, the nanowire core and the shell may have a mass ratio of 1:1 to 10:1.

The present disclosure is introduced to provide a method for preparing a graphene-vanadium oxide nanowire including: dispersing graphene oxide in an organic solvent to prepare a graphene oxide dispersion; adding vanadium oxide to the dispersion and reacting the vanadium oxide to prepare a graphene-vanadium oxide mixed solution; and heat-treating the mixed solution of the graphene-vanadium oxide, in which the heat treatment is performed at 300 to 500° C. for 1 to 4 hours.

Here, the preparing the graphene oxide dispersion may include dispersing by ultrasonic waves.

Here, the preparing the graphene-vanadium oxide may include further adding a strong acid.

Here, the vanadium oxide and the graphene oxide may be in a mass ratio of 1:1 to 4:1.

Here, the method further includes a pre-heat treatment before the heat treatment of the graphene-vanadium oxide mixed solution, in which the pre-heat treatment is performed at 100 to 140° C. for 12 to 48 hours.

A secondary battery including a graphene-vanadium oxide nanowire according to the present disclosure may include a positive active material for a secondary battery including a nanowire core including vanadium oxide, and a shell formed on the surface of the nanowire core and including graphene oxide, electrolyte; and a negative active material.

Here, the negative active material may include lithium metal, a lithium alloy, amorphous carbon containing lithium, or graphite carbon.

The graphene-vanadium oxide nanowire having improved capacity stability and the preparation method thereof can be provided by using the graphene-vanadium oxide nanowire according to the present disclosure, the preparation method thereof, and the positive active material and the secondary battery including the same.

In addition, by using the graphene-vanadium oxide nanowire according to the present disclosure as a positive active material, there is an advantage in that it is possible to provide a secondary battery having improved cycle characteristics and capacity retention rates.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 shows the results of a test of the capacity change of a battery prepared according to Preparation Example 1;

FIG. 2 shows the results of a test of the capacity change of a battery prepared according to Preparation Example 2;

FIG. 3 shows the results of a test of the capacity change of a battery prepared according to Comparative Preparation Example 1;

FIG. 4 is a graph showing a change in the capacity of a battery according to the number of cycles with a charging rate of 2 C (800 mA/g) in a battery prepared according to Preparation Example 1;

FIG. 5 is a graph showing a change in the capacity of a battery according to the number of cycles with a charging rate of 2 C (800 mA/g) in a battery prepared according to Preparation Example 2;

FIG. 6 is a graph showing a change in the capacity of a battery according to the number of cycles with a charging rate of 2 C (800 mA/g) in a battery prepared according to Comparative Preparation Example 1;

FIG. 7 is a graph showing a change in the capacity of a battery depending on a discharging rate, while changing the discharging rate of a battery prepared according to Preparation Example 1 to 0.1, 0.2, 0.5, 1.0, 2.0, and 5.0 C (40 mA/g, 80 mA/g, 200 mA/g, 400 mA/g, 800 mA/g, and 2,000 mA/g) with a charging rate of 0.1 C (40 mA/g);

FIG. 8 is a graph showing a change in the capacity of a battery depending on a discharging rate, while changing the discharging rate of a battery prepared according to Preparation Example 2 to 0.1, 0.2, 0.5, 1.0, 2.0, and 5.0 C (40 mA/g, 80 mA/g, 200 mA/g, 400 mA/g, 800 mA/g, and 2,000 mA/g) with a charging rate of 0.1 C (40 mA/g); and

FIG. 9 is a graph showing a change in the capacity of a battery depending on a discharging rate, while changing the discharging rate of a battery prepared according to Comparative Preparation Example 1 to 0.1, 0.2, 0.5, 1.0, 2.0, and 5.0 C (40 mA/g, 80 mA/g, 200 mA/g, 400 mA/g, 800 mA/g, and 2,000 mA/g) with a charging rate of 0.1 C (40 mA/g).

### DETAILED DESCRIPTION OF THE PREFERRED EMBODIMENT

Hereinafter, the present disclosure will be described in detail with reference to examples according to the present disclosure.

The present disclosure is suggested to provide a graphene-vanadium oxide nanowire having improved stability.

In addition, the present disclosure is suggested to provide a method for preparing graphene-vanadium oxide nanowires which is simple in preparation process and has improved capacity stability.

In addition, the present disclosure is suggested to provide a positive active material including graphene-vanadium oxide nanowires having improved stability and a secondary battery including the same.

The conventional method for preparing graphene-vanadium oxide nanowires has problems in that it is prepared under high temperature and high pressure conditions or is complicated in the preparation process. Moreover, it is almost impossible to control the physical properties of the positive active material including vanadium oxide.

In addition, the positive active material including the graphene-vanadium oxide nanowire has a problem in that the capacity is reduced through the irreversible phase change.

The present disclosure is designed to solve such problems, and provides a graphene-vanadium oxide nanowire having a simple preparation process and improved capacity stability.

The graphene described below refers to the reductive form of graphene oxide.

The graphene-vanadium oxide nanowire of the present disclosure includes a nanowire core including vanadium oxide and a shell formed on the surface of the nanowire core and including graphene oxide.

The core including the graphene-vanadium oxide is formed by covalent bonding, hydrogen bonding or ionic bonding to at least a part of the shell. The shell includes graphene oxide having a single layer or a laminated structure of two to five layers. In addition, the shell may further include graphene as well as graphene oxide because the graphene oxide is reduced to graphene to further increase electrical conductivity values.

That is, the shell may be bonded to a surface of the core in a closely and completely wrapping manner, or in a form of two to five folds, which further surrounds them.

Since the graphene-vanadium oxide nanowire having such a structure has a structure in which the shell wraps the core in various directions, the core, which is strongly bound to the shell, can inhibit the volume expansion of the positive active material by intercalation and deintercalation of lithium ions during charging and discharging reaction. The graphene-vanadium oxide nanowires can have high electrical conductivity values and high capacity values.

The graphene oxide and the graphene are preferably 70% by weight to 30% by weight and 30% by weight to 70% by weight based on 100% by weight of the shell. When the weight of the graphene oxide is 70% or higher, there is a problem in that the weight % of graphene is relatively reduced and the conductivity is lowered. When the weight of the graphene oxide is less than 30% by weight, the irreversibility is increased due to the large surface area of graphene, so that there is a problem in that the performance of an electrode is lowered. Thus, the above range is preferable.

The ratio of the graphene oxide to the graphene included in the shell can be determined by the heat-treatment temperature and will be described in detail in the following method for preparing the graphene-vanadium oxide nanowire.

The diameter of the graphene-vanadium oxide nanowire can be selected within the range of 10 nm to 200 nm. If the diameter is less than 10 nm, it has a wide surface and a high surface energy, but it is not preferable because of a thermodynamical instability. If the diameter is 200 nm or higher, the effect is insufficient, and it is not preferable from the viewpoint of energy.

The vanadium oxide may include at least one selected from the group consisting of VO₂, V₂O₅ and V₃O₈, preferably V₂O_{5.}

The VO₂, V₂O₅, and V₃O₈ have the advantages of higher capacity and excellent storability as the oxidation number increases. However, as the oxidation number of vanadium oxide increases, the charge transfer resistance increases rapidly during charge and discharge cycles, and there is a problem that the capacity is rapidly reduced due to spontaneous cohesion and decomposition, and thus V₂O₅ is preferable.

The nanowire core and the shell have a mass ratio of 1:1 to 10:1, and preferably a mass ratio of about 3:1. If the mass ratio of the core is less than 1, it cannot have a wide surface, and thus it is not preferable. If it is 10 or higher, the stability is poor due to high surface energy in proportion to a large surface, and thus it is not preferable.

The graphene-vanadium oxide nanowire of the present disclosure is used as a positive active material for a secondary battery having improved capacity stability.

Hereinafter, a method for preparing the graphene-vanadium oxide nanowire will be described.

A method for preparing a graphene-vanadium oxide nanowire according to an embodiment of the present disclosure includes: dispersing graphene oxide in an organic solvent to prepare a graphene oxide dispersion; adding vanadium oxide to the dispersion and reacting the vanadium oxide to prepare a graphene-vanadium oxide mixed solution; and heat-treating the mixed solution of the graphene-vanadium oxide, in which the heat treatment is performed at 300 to 500° C. for 1 to 4 hours.

First, the present disclosure includes dispersing graphene oxide in an organic solvent to prepare a graphene oxide dispersion.

The graphene oxide may be prepared and used, but is not limited thereto.

As an embodiment of a method for preparing the graphene oxide of the present disclosure, graphite having a particle of 300˜600 nm is prepared by mixing potassium persulfate (K₂S₂O₈), phosphorus pentoxide (P₂O₅), and sulfuric acid (H₂SO₄).

Next, the mixed solution may be washed with distilled water and dried at 25 to 35° C. for 1 to 24 hours to prepare a first reactant.

Potassium permanganate (KMnO₄), hydrogen peroxide (H₂O₂) and sulfuric acid (H₂SO₄) are added to the first reactant and completely oxidized to form a second reactant. The second reactant may be washed with 10 to 20% hydrochloric acid and distilled water alternately and dried at 40 to 50° C. for 1 to 5 days to prepare graphene oxide.

The organic solvent can be used by selecting one type, for example, of distilled water, ethanol, methanol, propanol, butanol, isopropyl alcohol, dimethylformamide (DMF), acetone, tetrahydrofuran (THF), toluene, dimethylacetamide, N, N-dimethylformamide, and N-methyl-2-pyrrolidone (NMP), but is not limited thereto.

The reason why graphene oxide is added to and dispersed in the organic solvent is to allow the graphene oxide to uniformly wrap the surface of the vanadium oxide. The dispersing method may follow a conventional method. In the present disclosure, the dispersion can be carried out for 10 to 30 minutes by an ultrasonic wave of 50 W and 45 kHz intensity using a disperser.

Next, a vanadium oxide is added to the dispered liquid and reacted to prepare a graphene-vanadium oxide mixed solution.

Vanadium oxide may be added to the dispersed liquid and stirred at 25 to 35° C. for 2 to 4 hours. Under the above conditions, a high adhesion between the graphene oxide and the vanadium oxide contained in the dispersed liquid can be given.

Here, the reason for stirring is that the graphene oxide included in the dispersed liquid can be bound in the form of completely wrapping the vanadium oxide.

In the preparing the graphene-vanadium oxide of the present disclosure, a strong acid may be further added.

The strong acid may include at least one type selected from the group consisting of sulfuric acid, hydrochloric acid, acetic acid, and perchloric acid, preferably hydrochloric acid, but is not limited thereto.

The reason for further adding the strong acid is that by providing the cation in the solvent, the cation can help accelerate the growth of the mixed solution in nanowire form from the bulk form.

In addition, it is preferable that the vanadium oxide and the graphene oxide are present in a mass ratio of 1:1 to 4:1, preferably about 3:1.

In the method for preparing a graphene-vanadium oxide of the present disclosure, the vanadium oxide and the graphene oxide are present in a mass ratio ranging from 1:1 to 4:1. At the time of preparation, the nanowire core and the shell can prepare a graphene-vanadium oxide within the range of a mass ratio of 1:1 to 10:1.

The reason why the mass ratio is reduced in the above process is that the mass of the shell is reduced by removing oxygen functional groups attached to the graphene oxide during the heat treatment.

If the mass ratio of the graphene oxide is less than 1, it cannot have a wide surface, and thus it is not preferable. If it is 4 or higher, it has an excessively large surface, the stability is poor due to high surface energy in proportion thereto, and thus the range is preferable.

Next, the present disclosure includes heat-treating the mixed solution of the graphene-vanadium oxide.

The heat treatment of the mixed solution of graphene-vanadium oxide of the present disclosure is a step in which the mixed solution of graphene-vanadium oxide is grown to a graphene-vanadium oxide nanowire to give battery characteristics.

The graphene-vanadium oxide mixed solution proceeded up to the above-mentioned processing process can grow into the graphene-vanadium oxide nanowire with time, but since there is no battery characteristic, the following graphene-vanadium oxide mixed solation may be subjected to a heat treatment to give battery characteristics.

In addition, the graphene oxide acts as a weak oxidizing agent during the process of growing the graphene-vanadium oxide nanowire, thereby accelerating the growth of the nanowire.

The heat treatment of the graphene-vanadium oxide mixed solution may be performed at 300 to 500° C. for 1 to 4 hours. The heat treatment of the graphene-vanadium oxide mixed solution may be performed in a nitrogen atmosphere, but is not limited thereto.

If the temperature is less than 300° C., the mass ratio of the graphene oxide reduced to graphene is lowered and the ionic conductivity is lowered. If the temperature is 500° C. or higher, the weight% of the graphene increases and irreversibility increases. Thus, there is a problem in that the performance of an electrode is lowered, so that the above range is preferable.

In order to increase the content of the graphene oxide in the heat treatment of the graphene-vanadium oxide mixed solution, the heat treatment may be performed at a relatively low temperature within the temperature range. In order to increase the graphene content, the heat treatment may be performed at a relatively high temperature within the temperature range.

The present disclosure may further include a pre-heat treatment before the heat treatment of the graphene-vanadium oxide mixed solution, in which the pre-heat treatment is performed at 100 to 140° C. for 12 to 48 hours.

The graphene-vanadium oxide mixed solution may grow into graphene-vanadium oxide nanowires without battery characteristics in the range of about 8 weeks to 10 weeks.

In the preparation method for the present disclosure, the pre-heat treatment may be performed at 100 to 140° C. for 12 to 48 hours, and the pre-heat treatment is performed to accelerate the growth of nanowires. At the time of growing graphene-vanadium oxide nanowires, when the temperature is lower than 100° C., the growth of the nanowire becomes slow. When the temperature is 140° C. or higher, the growth rate of the nanowire is fast, but the nanowire may be structurally unstable. Thus, the above range is preferable.

Hereinafter, a secondary battery according to the present disclosure will be described in detail.

The secondary battery of the present disclosure includes a nanowire core including vanadium oxide, and a shell formed on the surface of the nanowire core and including graphene oxide, electrolyte; and a negative active material.

The electrolyte may be a non-aqueous organic solvent, an organic solid electrolyte, or an inorganic solid electrolyte, but is not limited thereto.

The negative active material may include lithium metal, a lithium alloy, amorphous carbon containing lithium, or graphite carbon. Examples include a carbon material capable of electrochemically intercalating/deintercalating lithium, such as a lithium metal-containing alloy and graphite such as lithium-aluminum, lithium-zinc, lithium-tin, lithium-aluminum-tin, lithium-gallium, and wood alloys. More preferably, as a carbon material, a graphite particle to which amorphous carbon is attached to the surface is preferable, but is not limited thereto.

In addition, the positive active material included in the secondary battery is the same as that described above, and the preparation method thereof has been fully described, and thus the description thereof will be omitted.

### EXAMPLES

Hereinafter, the present disclosure will be described in further detail with reference to embodiments according to the present disclosure.

### Example 1

### Preparation of Graphene-Vanadium Oxide Nanowire 1

First, 0.1 g of graphene oxide was added to 30 ml of distilled water and dispersed by an ultrasonic wave disperser at 25° C. for 20 minutes.

Next, 0.3 g of V₂O₅ powder and 1 ml of HCl were mixed in the dispersed liquid prepared above, and the mixture was stirred at 30° C. for 2 hours.

The stirred graphene-vanadium oxide solution was prepared by pre-heat treatment at 120° C. for 24 hours.

Next, the heat-treated graphene-vanadium oxide nanowire was washed with distilled water three times and vacuum-dried at 50° C. for 5 hours to prepare graphene oxide-vanadium oxide nanowire.

Next, the graphene oxide-vanadium oxide nanowire prepared above was subjected to heat treatment (graphene reduction) in a nitrogen atmosphere at 500° C. for 2 hours to complete the preparation of the graphene-vanadium oxide nanowire.

### Example 2

### Preparation of Graphene-Vanadium Oxide Nanowire 2

The graphene-vanadium oxide nanowire was prepared in the same manner as in Example 1 except that the heat-treatment (graphene reduction) was performed at 400° C.

### Comparative Example 1

### Preparation of Graphene-Vanadium Oxide Nanowire 3

The graphene-vanadium oxide nanowire was prepared in the same manner as in Example 1 except that the heat-treatment (graphene reduction) was performed at 300° C.

### Preparation Example 1

### Preparation of CR2016 Type Coin Cell 1

First, 0.8 g of the graphene-vanadium oxide nanowire prepared in Example 1, 0.1 g of carbon black, and 0.1 g of polyvinylidene fluoride were added to 2 ml of N-methyl-2-pyrrolidone to prepare a slurry.

Next, the slurry is coated on an aluminum foil and dried at 120° C. for 12 hours.

After the dried electrode was rolled, a coin cell was prepared using a lithium electrode and a separator nickel mesh in a glove box.

At that time, 1 M LiPF₆ in EC:DEC (1:1) was used as the electrolyte.

Here, EC is ethylene carbonate and DEC is diethyl carbonate.

### Preparation Example 2

### Preparation of CR2016 Type Coin Cell 2

A coin cell was prepared in the same manner as in Preparation Example 1 except that the graphene-vanadium oxide nanowire prepared in Example 2 was used instead of the graphene-vanadium oxide nanowire of Example 1.

### Comparative Preparation Example 1

### Preparation of CR2016 Type Coin Cell 1

A coin cell was prepared in the same manner as in Preparation Example 1 except that the graphene-vanadium oxide nanowire prepared in Comparative Example 1 was used instead of the graphene-vanadium oxide nanowire of Example 1.

{Evaluation Results}

### Experimental Example 1

### Charging, Discharging and Capacity Test

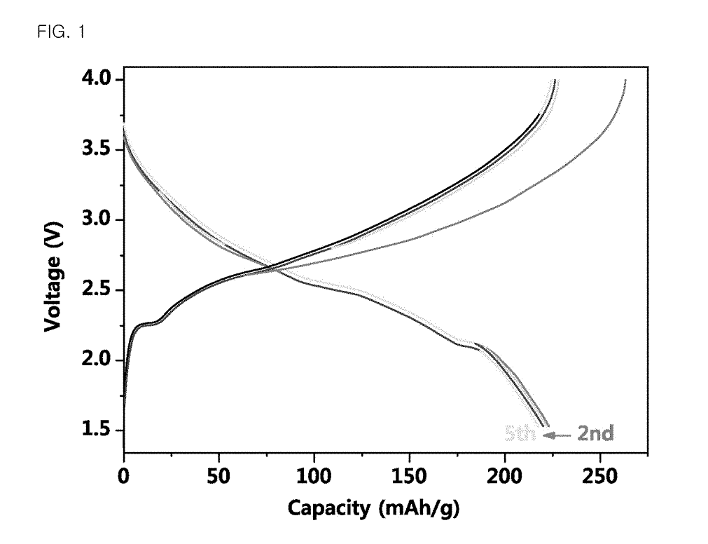

In order to evaluate the capacity of a secondary battery including the graphene-vanadium oxide nanowire according to the present disclosure as a positive active material, the battery prepared by the methods of Preparation Examples 1 and 2 and Comparative Preparation Example 1 was fixed at a charging and discharging rate of 0.1 C (40 mA/g), and charging and discharging tests were carried out. The results are shown in FIGS. 1 to 3.

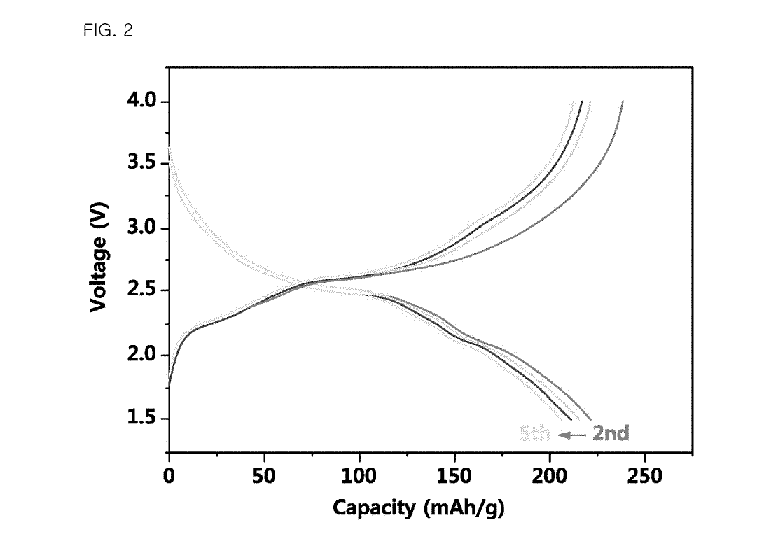

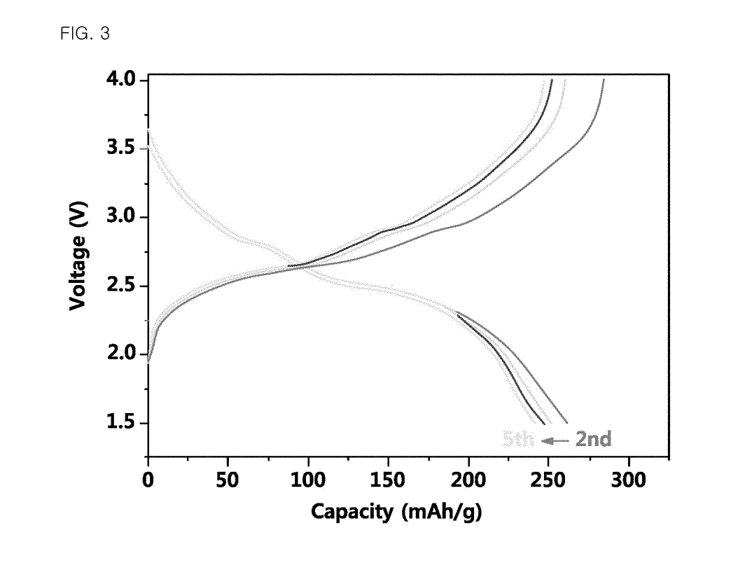

FIGS. 1 and 2 are graphs showing the results of testing each of the capacity changes of batteries prepared according to Preparation Examples 1 and 2. FIG. 3 is a graph showing a result of testing a capacity change of a battery prepared according to Comparative Preparation Example 1.

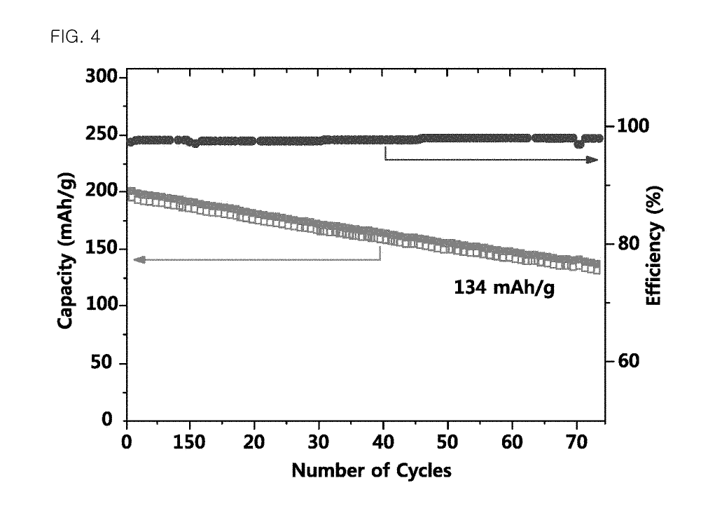

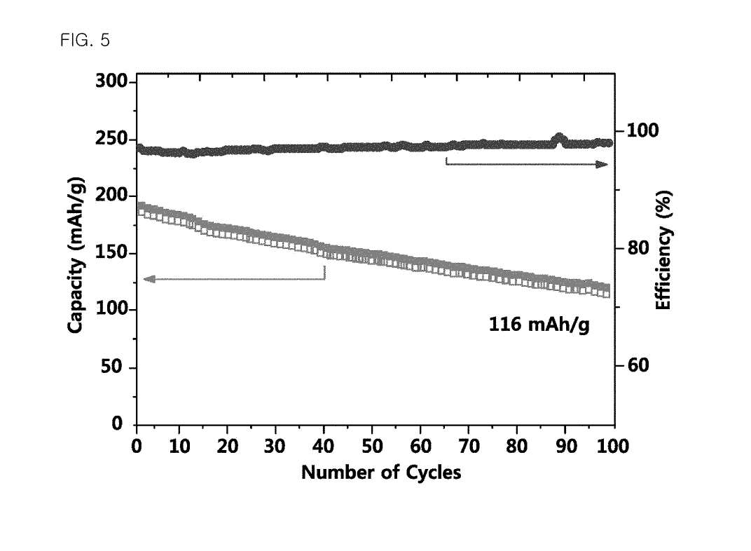

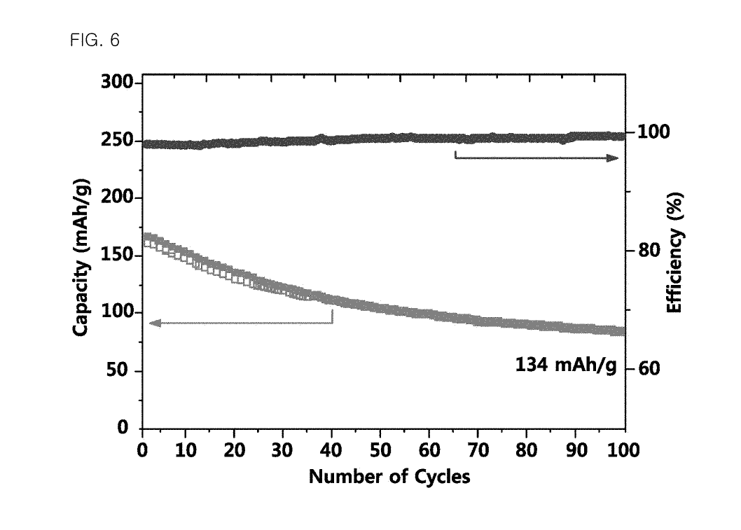

FIGS. 4 and 5 are graphs showing changes in the capacity of the battery according to the number of cycles at a charging rate of 2 C (800 mA/g), respectively, in a battery prepared according to Preparation Examples 1 and 2. FIG. 6 is a graph showing a change in the capacity of a battery according to the number of cycles with a charging rate of 2 C (800 mA/g), in a battery prepared according to Comparative Preparation Example 1.

As a result, as shown in FIG. 1, the battery of Preparation Example 1 including the graphene-vanadium oxide nanowire heat-treated at 500° C. as a positive active material was stable after 70 cycles, and it was confirmed that a high capacity retention rate compared with the initial capacity was shown.

On the other hand, as shown in FIG. 3, the battery of Comparative Preparation Example 3 including the graphene-vanadium oxide nanowire heat-treated at 300° C. as a positive active material was unstable after 70 cycles, and it was confirmed that a log capacity retention rate compared with the initial capacity was shown.

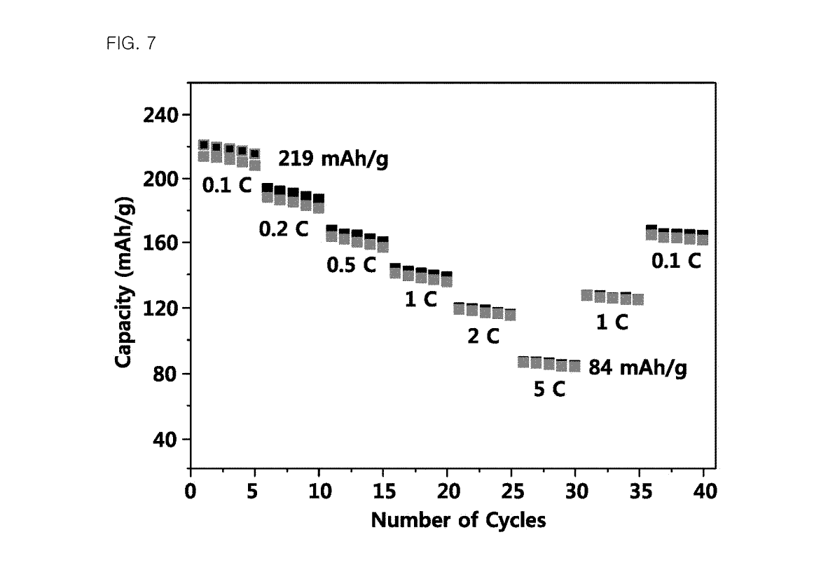

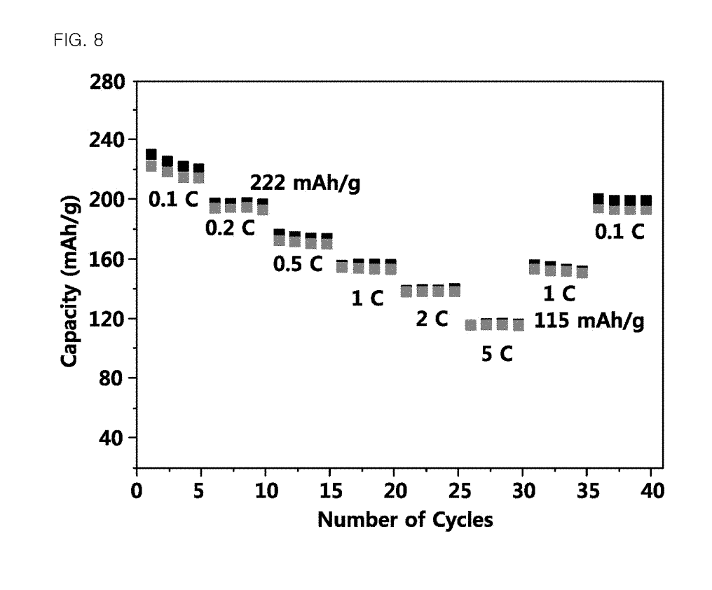

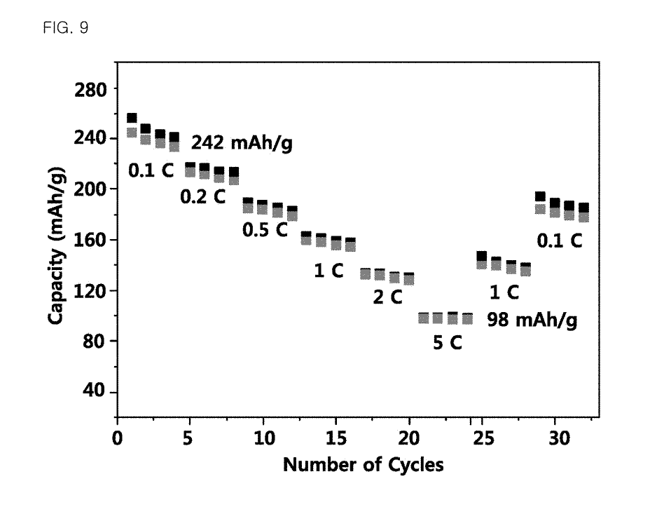

FIGS. 7 and 8 are graphs showing a change in the capacity of a battery depending on a discharging rate, while changing the discharging rate of a battery prepared according to Preparation Examples 1 and 2 to 0.1, 0.2, 0.5, 1.0, 2.0, and 5.0 C (40 mA/g, 80 mA/g, 200 mA/g, 400 mA/g, 800 mA/g, and 2,000 mA/g) with a charging rate of 0.1 C (40 mA/g). FIG. 9 is a graph showing a change in the capacity of a battery depending on a discharging rate, while changing the discharging rate of a battery prepared according to Comparative Preparation Example 1 to 0.1, 0.2, 0.5, 1.0, 2.0, and 5.0 C (40 mA/g, 80 mA/g, 200 mA/g, 400 mA/g, 800 mA/g, and 2,000 mA/g) with a charging rate of 0.1 C (40 mA/g).

As a result, it was confirmed that the battery prepared according to Preparation Example 1 including the graphene-vanadium oxide nanowire heat-treated at 500° C. as a positive active material shows a stable capacity and retention rate as a result of charging and discharging tests as compared to the battery prepared according to Comparative Preparation Example 1 including the graphene-vanadium oxide nanowire heat-treated at 3500° C. as a positive active material.

As discussed above, the present disclosure was described in detail by way of preferable examples. The scope of the present disclosure is not limited by some examples, but should be interpreted by the appended claims. In addition, it will be appreciated by a person having ordinary skill in the pertinent technical field that various modifications and variations are possible without departing from the scope of the present disclosure.

What is claimed is:

1. A graphene-vanadium oxide nanowire comprising a nanowire core including vanadium oxide and a shell formed on a surface of the nanowire core and including graphene oxide.

2. The graphene-vanadium oxide nanowire according to claim 1, wherein the shell has graphene and graphene oxide.

3. The graphene-vanadium oxide nanowire according to claim 1, wherein the vanadium oxide includes at least one selected from a group consisting of VO₂, V₂O₅, and V₃O₈.

4. The graphene-vanadium oxide nanowire according to claim 1, wherein the nanowire core and the shell are in a mass ratio of 1:1 to 10:1.

5. An active material for a secondary battery, the active material comprising a nanowire core including vanadium oxide, and a shell formed on a surface of the nanowire core and including graphene oxide.

6. The active material for a secondary battery according to claim 5, wherein the shell has graphene and graphene oxide.

7. The active material for a secondary battery according to claim 5, wherein the vanadium oxide includes at least one selected from a group consisting of VO₂, V₂O₅, and V₃O₈.

8. The active material for a secondary battery according to claim 5, wherein the nanowire core and the shell are in a mass ratio of 1:1 to 10:1.

9. A method for preparing a graphene-vanadium oxide nanowire, the method comprising:
dispersing graphene oxide in an organic solvent to prepare a graphene oxide dispersion;
adding vanadium oxide to the dispersion and reacting the vanadium oxide to prepare a graphene-vanadium oxide mixed solution; and
heat treating the mixed solution of the graphene-vanadium oxide,
wherein the heat treatment is performed at 300 to 500° C. for 1 to 4 hours.

10. The method according to claim 9, wherein the graphene oxide dispersion is dispersed by ultrasonic waves.

11. The method according to claim 9, wherein the preparing the graphene-vanadium oxide further includes adding a strong acid.

12. The method according to claim 9, wherein the vanadium oxide and the graphene oxide are in a mass ratio of 1:1 to 4:1.

13. The method according to claim 9, further comprising a pre-heat treatment before the heat treatment of the graphene-vanadium oxide mixed solution, wherein the pre-heat treatment is performed at 100 to 140° C. for 12 to 48 hours.

14. A secondary battery, comprising:
a positive active material for a secondary battery including a nanowire core including vanadium oxide, and a shell formed on a surface of the nanowire core and including graphene oxide;
electrolyte; and
a negative active material.

15. The secondary battery according to claim 14, wherein the negative active material has lithium metal, a lithium alloy, amorphous carbon containing lithium, or graphite carbon.
